(19) United States
(12) Patent Application Publication
(10) Pub. No.: US 2003/0097378 A1
(43) Pub. Date: May 22, 2003

(54) Method and system for removing text-based viruses

(76) Inventors: Khai Pham, Beaverton, OR (US); Dmitry Gryaznov, Portland, OR (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/988,600

(22) Filed: Nov. 20, 2001

(51) Int. Cl. G06F 12/00

(52) U.S. Cl. 707/200

(57) ABSTRACT

A system, method, and computer program product that provides the capability to remove a macro or script virus from a document or file and leave the remainder of the document or file intact. An anti-virus program executable by a computer system comprises virus scanning routines operable to scan a file and detect a virus, virus removal routines operable to remove the detected virus from the file, the virus removal routines comprising a text editor, operable to search and modify a textual portion of the file under control of virus removal instructions, and the virus removal instructions, which are operable to cause the text editor to remove a virus from the textual portion of the file. The removed virus may be located on one line of text or the removed virus may be located on a plurality of lines of text.

### FIELD OF THE INVENTION

The present invention relates to a method a system for removing text-based viruses from textual portions of files.

### BACKGROUND OF THE INVENTION

As the popularity of the Internet has grown, the proliferation of computer viruses has become more common. A computer virus is a program or piece of code that is loaded onto a computer without the knowledge or consent of the computer operator. Most viruses replicate themselves and load themselves onto other connected computers. One common type of computer virus is known as a macro or script virus. Rather than the virus comprising executable or object code, a macro virus comprises macro source code that is executed by a macro capable software application. Many modem software applications are macro capable, which allows customized feature and functions to be easily added. However, the capability to execute macro code also makes these applications vulnerable to macro viruses.

Unlike file executable viruses, macro viruses are typically text-based, as is the macro code itself. This means that the source code of the virus is always available and that an existing virus can be easily modified by use of a text editor program. Indeed, a common practice used be writers of computer viruses is to copy and paste the virus source into ordinary text, which may create a new virus.

When macro and script viruses infect documents, it is desirable to remove the viruses from the documents while keeping the remainder of each document intact. However, a problem arises in that macro and script viruses are hard to remove, without deleting the entire document, because they are source code, not compiled code. In the case of compiled code, the code can be distinguished from non-code, such as comments, strings, identifiers, etc. In the case of source code, the source code that comprises the virus is hard to distinguish from the remainder of the document. As a result, anti-virus software that detects macro and script viruses typically cannot repair an infected document by removing the virus source code and leaving the remainder of the document intact. Rather, such prior art software simply deletes the entire document. A need arises for a technique by which a macro or script virus can be removed from a document that leaves the remainder of the document intact.

### SUMMARY OF THE INVENTION

The present invention is a system, method, and computer program product that provides the capability to remove a macro or script virus from a document or file and leave the remainder of the document or file intact.

In one embodiment of the present invention, an anti-virus program executable by a computer system, comprises virus scanning routines operable to scan a file and detect a virus, virus removal routines operable to remove the detected virus from the file, the virus removal routines comprising a text editor, operable to search and modify a textual portion of the file under control of virus removal instructions, and the virus removal instructions, which are operable to cause the text editor to remove a virus from the textual portion of the file. The removed virus may be located on one line of text or the removed virus may be located on a plurality of lines of text. The text editor may comprise a search function operable to search a textual portion of a file using a regular expression specifying a pattern of text to be matched. The text editor may comprise a mark function operable to mark text matching the regular expression that was found by the search function. The text editor may comprise a delete function operable to delete text marked by the mark function. The mark function may be operable to mark a start of text and an end of text. The delete function may be operable to delete text between the marked start of text and the marked end of text. The deleted text may be located on one line of text or the deleted text may be located on a plurality of lines of text. The search function may be operable to search for a start of text to be marked and the mark function is operable to mark a start marker at the start of text; the search function may be operable to search for an end of text to be marked and the mark function is operable to mark an end marker at the end of text; and the delete function may be operable to delete text between the start marker and the end marker.

In one embodiment of the present invention, a method for removing a virus from a textual portion of a file infected with a virus comprises the steps of loading the infected file, searching the infected file to locate text associated with the virus, marking the located text and deleting the marked text. The searching step may comprise the step of searching the infected file using a regular expression specifying a pattern of text to be matched. The searching step may comprise the step of searching for a pattern of text associated with a start of text associated with the virus. The marking step may comprise the step of placing a start marker at a start of text associated with the virus. The searching step may comprise the step of searching for a pattern of text associated with an end of text associated with the virus. The marking step may comprise the step of placing an end marker at an end of text associated with the virus. The deleting step may comprise the step of deleting text between the start marker and the end marker.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of processing performed by an anti-virus program that incorporates the present invention.

FIG. 2 is a block diagram of an exemplary computer system in which the present invention may be implemented.

FIG. 3 is a block diagram of operation of a text editor, which exemplifies the present invention.

FIG. 4 is an exemplary flow diagram of a process for removing a virus from an infected file containing text.

FIG. 5a is a portion of an exemplary flow diagram of a process performed by a step of the process shown in FIG. 4.

FIG. 5b is a portion of an exemplary flow diagram of a process performed by a step of the process shown in FIG. 4.

FIG. 6 is an exemplary flow diagram of a process performed by a step of the process shown in FIG. 4.

FIG. 7 is an exemplary flow diagram of a process performed by a step of the process shown in FIG. 4.

### DETAILED DESCRIPTION OF THE INVENTION

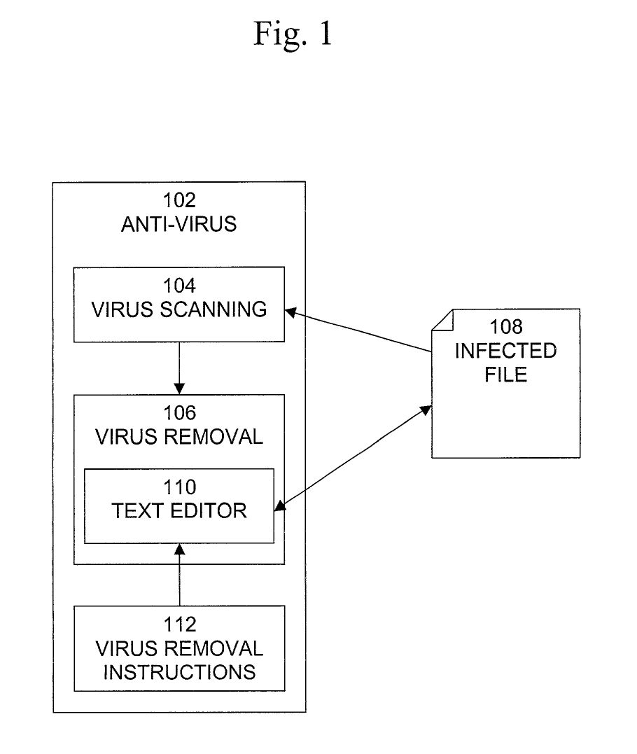

Th e processing performed by an anti-virus program that incorporates the present invention is shown in FIG. 1. Anti-virus program 102 includes virus scanning routines 104 and virus removal routines 106. Using virus scanning routines 104, anti-virus program 102 scans files until an infected file, such as infected file 108, is found. An infected file is a file that includes one or more computer viruses. The scanned files may include any types of files and may include textual information, which may be included in documents or which may be separate from documents, and may also include non-textual data, graphics, audio, video, or other information. Anti-virus program 102 then uses virus removal routines 106 to remove instances of the virus from infected file 108. If infected file 108 includes textual information that is infected with a computer virus, virus removal routines 106 use a text editor 110, which can search and modify the textual portions of files such as infected file 108, to remove instances of the virus from the textual portions of infected file 108. The particular searches and modifications performed by text editor 110 are specified by virus removal instructions 112. Typically, the particular virus removal instructions performed by text editor 110 in order to remove the virus from infected file 108 are selected based on the identity of the virus to be removed. Virus scanning routines 104 not only detect the presence of a virus, but also identify the virus. That virus identity may then be used to select the particular virus removal instructions to be used from among all of the virus removal instructions 112.

For example, consider the following hypothetical macro-virus code:

Sub VirusCode( )

'Infect file

Append Text “Sub VirusCode( )” to host document

Append virus body text

If time==2001 then Append “Msgbox You are Infected”

Append Text “End Sub” to host document

End Sub

To properly remove the virus from a file, virus removal routines 106 must correctly determine that the first instance of the text “End Sub” is part of the virus-infection code and actually not the end of the virus itself. The end of the virus itself is the second instance of the “End Sub” text. An inelegant method to do this is to search for two instance of “End Sub”. Sometimes that naive approach is not always possible because the behavior of the virus is polymorphic, for example, it may not insert some instances of text (such as the notification message that the user is infected, above). The present invention provides a more flexible solution.

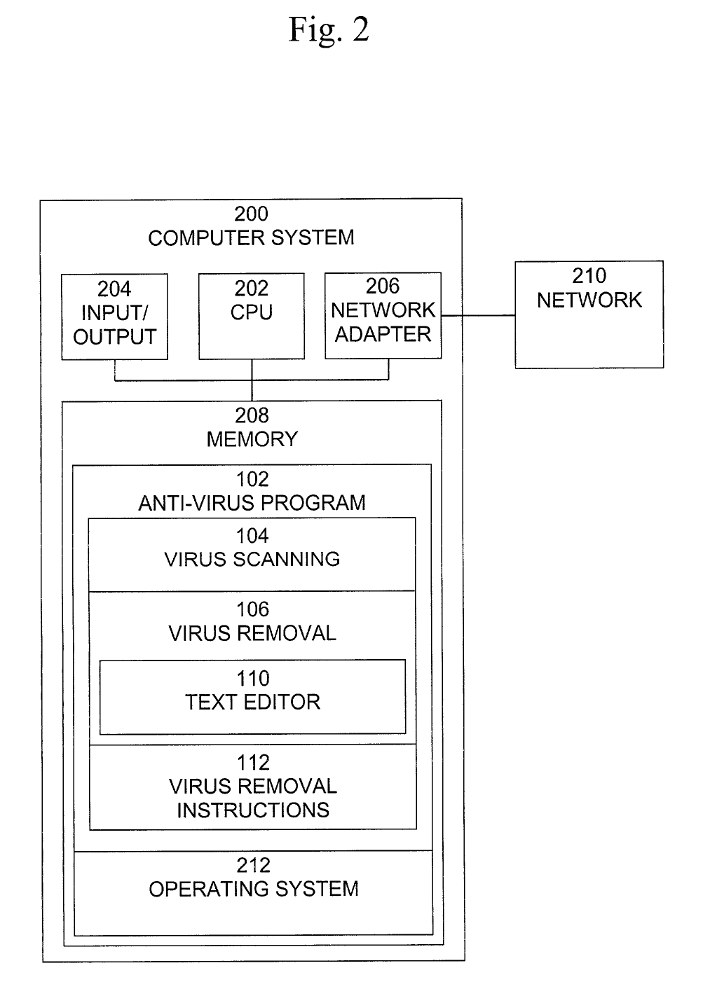

A block diagram of an exemplary computer system 200, in which the present invention may be implemented, is shown in FIG. 2. Computer system 200 is typically a programmed general-purpose computer system, such as a personal computer, workstation, server system, and minicomputer or mainframe computer. Computer system 200 includes processor (CPU) 202, input/output circuitry 204, network adapter 206, and memory 208. CPU 202 executes program instructions in order to carry out the functions of the present invention. Typically, CPU 202 is a microprocessor, such as an INTEL PENTIUM® processor, but may also be a minicomputer or mainframe computer processor. Although in the example shown in FIG. 2, computer system 200 is a single processor computer system, the present invention contemplates implementation on a system or systems that provide multiprocessor, multi-tasking, multi-process, multi-thread computing, distributed computing, and/or networked computing, as well as implementation on systems that provide only single processor, single thread computing. Likewise, the present invention also contemplates embodiments that utilize a distributed implementation, in which computer system 200 is implemented on a plurality of networked computer systems, which may be single-processor computer systems, multi-processor computer systems, or a mix thereof.

Input/output circuitry 204 provides the capability to input data to, or output data from, computer system 200. For example, input/output circuitry may include input devices, such as keyboards, mice, touchpads, trackballs, scanners, etc., output devices, such as video adapters, monitors, printers, etc., and input/output devices, such as, modems, etc. Network adapter 206 interfaces computer system 200 with network 210. Network 210 may be any standard local area network (LAN) or wide area network (WAN), such as Ethernet, Token Ring, the Internet, or a private or proprietary LAN/WAN.

Memory 208 stores program instructions that are executed by, and data that are used and processed by, CPU 202 to perform the functions of the present invention. Memory 208 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 208 includes anti-virus program 102 and operating system 212. Anti-virus program 102 includes virus scanning routines 104, virus removal routines 106, and virus removal instructions 112. Anti-virus program 102 scans files using virus scanning routines 104 until an infected file is found. Anti-virus program 102 then uses virus removal routines 106 to remove instances of the virus from infected file 108. Virus removal routines 106 use a text editor 110, which can search and modify the text based portions files such as infected file 108. The particular searches and modifications performed by text editor 110 are specified by virus removal instructions 112. Although not shown in FIG. 2, the files that are scanned, as well as infected files, may be stored in memory 208, or they may be stored in other computer systems that may be connected via network 210. Operating system 212 provides overall system functionality.

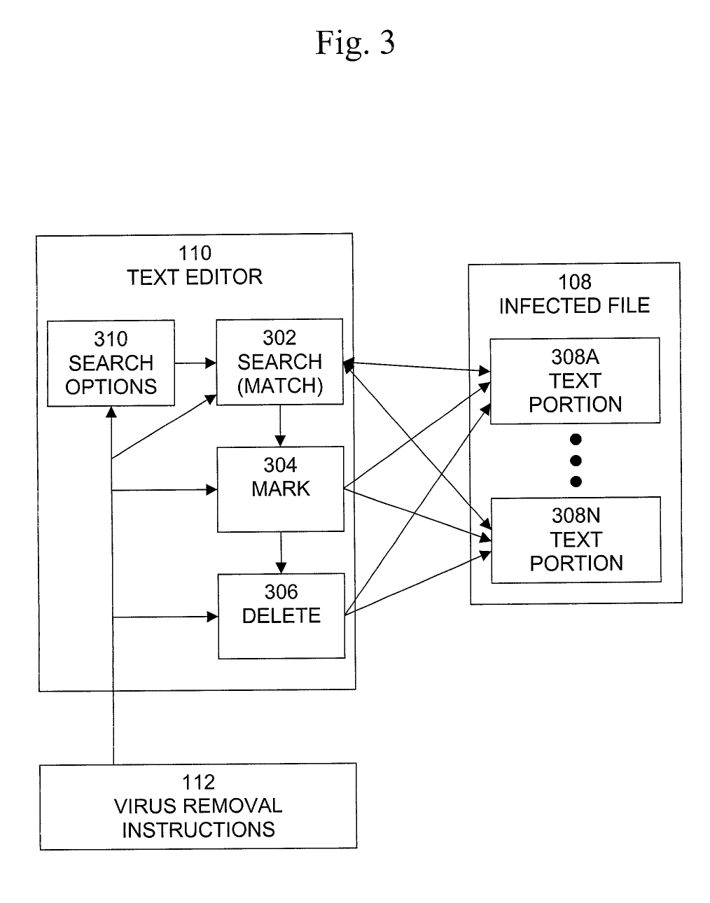

A block diagram of operation of a text editor 110, which exemplifies the present invention, is shown in FIG. 3. Text editor 110 is capable of performing a plurality of functions, including search 302, mark 304, and delete 306 functions. Text editor 110 performs these functions as specified by virus removal instructions 112, which include instructions that specify how to remove the virus that has been identified as infecting infected file 108. Infected file 108 includes at least one text portion, such as text portion 308A, and may include additional text portions, such as text portion 308N, as well as additional information (not shown). The additional information may be of any type, such as non-textual data, graphics, audio, video, or other information.

Search function 302 scans a text portion, such as text portion 308A, of an infected file, such as infected file 108, and attempts to match data in file 108 with a search specification defined in the virus removal instruction that specified the search. Preferably, the search specification is in the form of a “regular expression”, such as that used by the well-known text search program egrep. In addition to the search specification defined in the virus removal instruction, the search specification is further defined by search options 310, which are in effect at the time of the search. Search options 310 are specified by virus removal instructions and remain in effect for subsequent searches, until changed by additional virus removal instructions.

Once data in file 108 that matches the search specification has been found, the marking function 304 marks that data as specified in a virus removal instruction. Typically, matching is done line by line of the text and markers are placed at the matched text. After two markers denoting start and end positions have been set, the text information between the markers is deleted by delete function 306, as specified in a virus removal instruction.

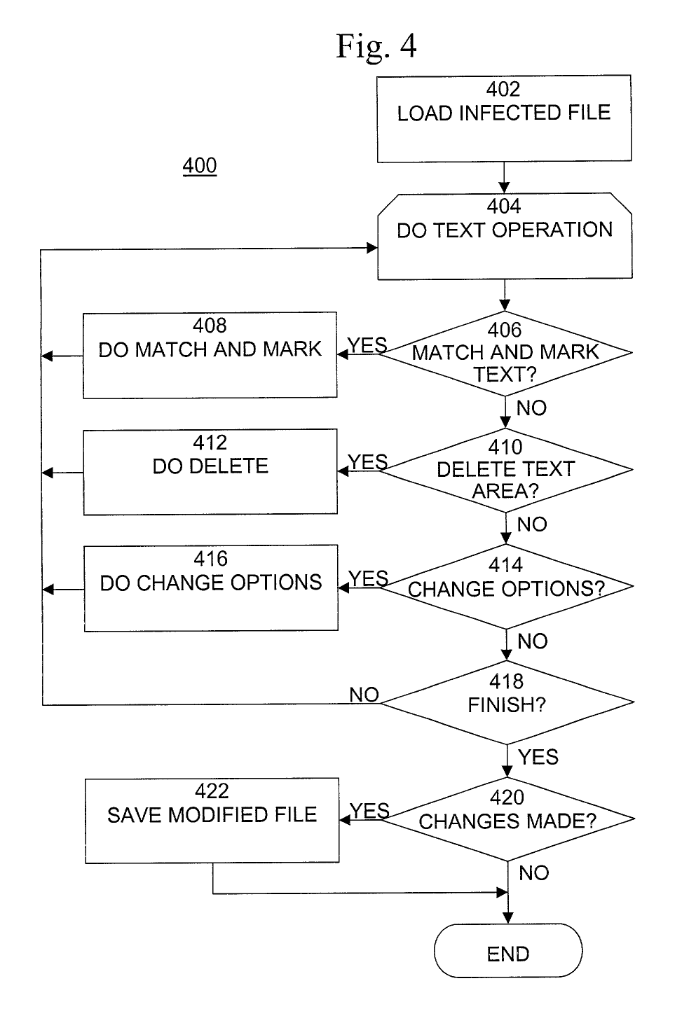

An exemplary flow diagram of a process 400 for removing a virus from an infected file containing text, after it has been determined that the file is infected and the virus identified, is shown in FIG. 4. Process 400 beings with step 402, in which an infected file is loaded into the text editor that will remove the virus. In step 404, a loop is entered in which the virus removal instructions corresponding to the identified virus are sequentially performed by the text editor. In step 404, the next virus removal instruction to be performed is fetched.

In step 406, it is determined whether the instant virus removal instruction specifies matching and marking of text. If the instant virus removal instruction specifies matching and marking of text, then process 400 continues with step 408, in which text in the infected file is matched and marked as specified in the instant virus removal instruction. Process 400 then loops back to step 404, in which the next virus removal instruction to be performed is fetched.

If, in step 406, it is determined that the instant virus removal instruction does not specify matching and marking of text, then process 400 continues with step 410, in which it is determined whether the instant virus removal instruction specifies deletion of a marked text area. If the instant virus removal instruction specifies deletion of a marked text area, then process 400 continues with step 412, in which the marked text area specified in the instant virus removal instruction is deleted from the infected file. Process 400 then loops back to step 404, in which the next virus removal instruction to be performed is fetched.

If, in step 410, it is determined that the instant virus removal instruction does not specify deletion of a marked text area, then process 400 continues with step 414, in which it is determined whether the instant virus removal instruction specifies that text search options, which will apply to subsequent searches, are to be changed. If the instant virus removal instruction specifies that text search options are to be changed, then process 400 continues with step 416, in which the text search options specified in the instant virus removal instruction are changed. Process 400 then loops back to step 404, in which the next virus removal instruction to be performed is fetched.

If, in step 414, it is determined that the instant virus removal instruction does not specify that text search options are to be changed, then process 400 continues with step 418, in which it is determined whether the virus removal process is finished. This is determined based on whether there are any virus removal instructions remaining to be performed. If the virus removal process is not finished, then process 400 loops back to step 404, in which the next virus removal instruction to be performed is fetched.

If, in step 418, it is determined that the virus removal process is finished, then process 400 continues with step 420, in which it is determined whether any changes were actually made to the infected file. If changes were actually made to the infected file, then process 400 continues with step 422, in which the modified file is saved. Process 400 then ends. If, in step 420, it is determined that no changes were actually made to the infected file, then process 400 ends.

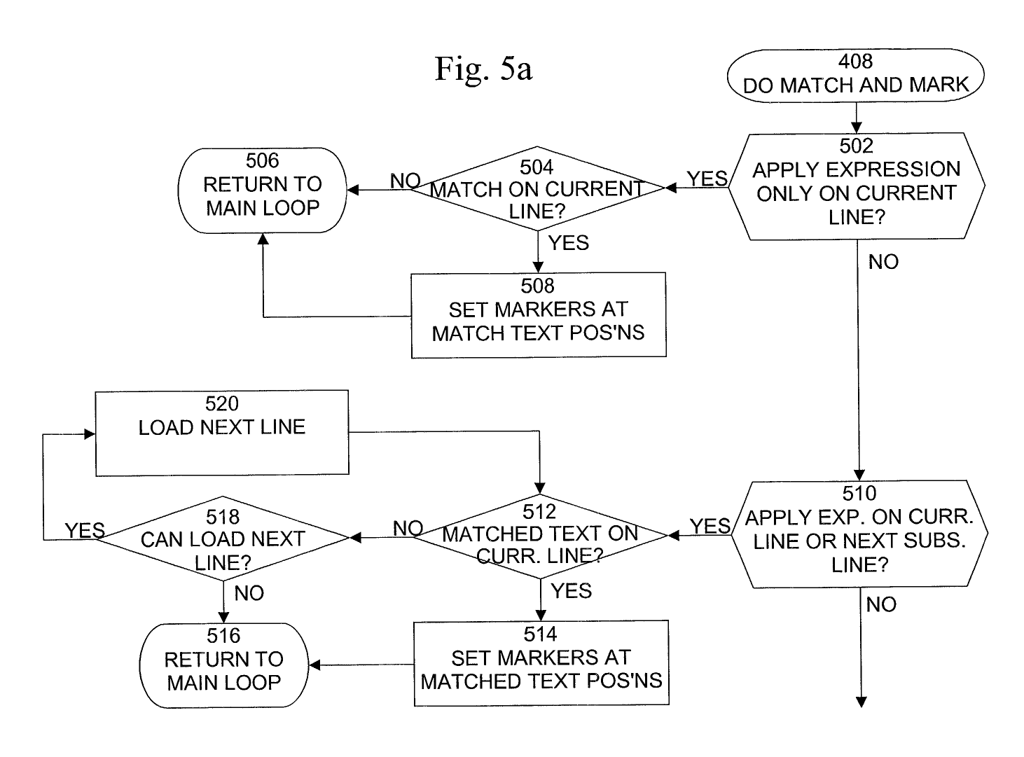

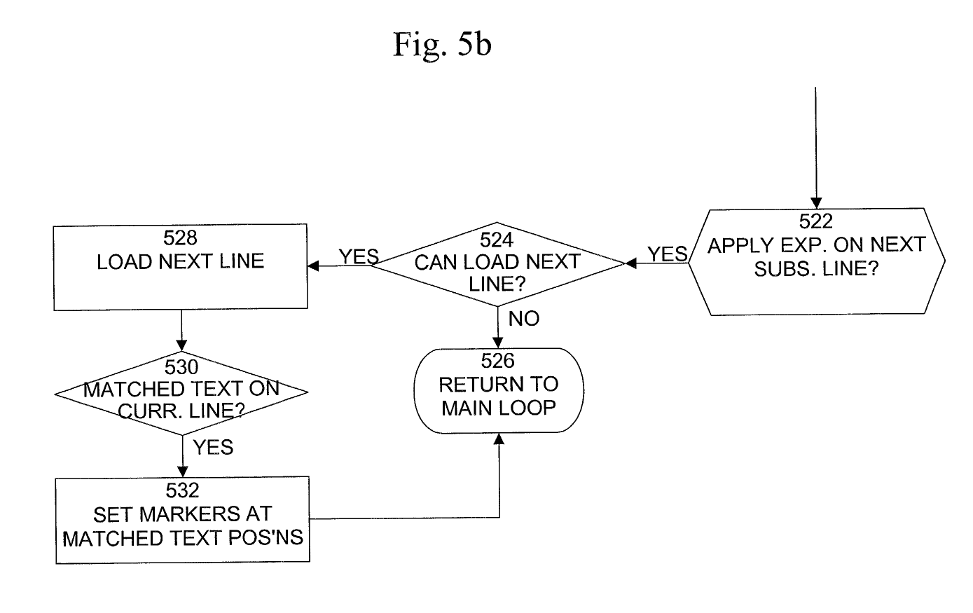

An exemplary flow diagram of a process performed by step 408 of FIG. 4, which performs the search and mark functions, is shown in FIGS. 5a and 5b. The process of step 408 begins with step 502, shown in FIG. 5a, in which it is determined whether the regular expression specified by the instant virus removal instruction is to be applied only on the current line of text being processed. If the regular expression is to be applied only on the current line, the process continues with step 504, in which it is determined whether information included in the current line matches information specified by the regular expression. If no information included in the current line matches information specified by the regular expression, then the process continues with step 506, and returns to the main loop at step 410 of FIG. 4.

If information included in the current line matches information specified by the regular expression, then the process continues with step 508, in which markers are set at the matched text positions. In particular, a start marker is set at the start position of the matched text and an end marker is set at the end position of the matched text. Thus, the start and end markers are set so as to enclose the matched text. The process then continues with step 506, and returns to the main loop at step 410 of FIG. 4.

If, in step 502, it is determined that the regular expression specified by the instant virus removal instruction is not to be applied only on the current line of text being processed, then the process continues with step 510, in which it is determined whether the regular expression specified by the instant virus removal instruction is to be applied on the current line of text being processed or on the next subsequent line of text being processed. If the regular expression specified by the instant virus removal instruction is to be applied on the current line or on the next subsequent line, then the process continues with step 512, in which it is determined whether information included in the current line matches information specified by the regular expression. If information included in the current line matches information specified by the regular expression, then the process continues with step 514, in which markers are set at the matched text positions. In particular, a start marker is set at the start position of the matched text if the start position has been matched and an end marker is set at the end position of the matched text if an end position has been matched. The process then continues with step 516, and returns to the main loop at step 410 of FIG. 4.

If, in step 512, it is determined that information included in the current line does not match information specified by the regular expression, then the process continues with step 518, in which it is determined whether the next line of text can be loaded for processing. If the next line of text cannot be loaded for processing, the process continues with step 516, and returns to the main loop at step 410 of FIG. 4. If the next line can be loaded for processing, then the process continues with step 520, in which the next line is loaded for processing. The process then continues with step 512.

If, in step 510, it is determined that the regular expression specified by the instant virus removal instruction is not to be applied on the current line of text being processed or on the next subsequent line of text being processed, then the process continues with step 522, shown in FIG. 5b, in which it is determined whether the regular expression specified by the instant virus removal instruction is to be applied on the next subsequent line of text being processed. If the regular expression specified by the instant virus removal instruction is to be applied on the next subsequent line of text being processed, then the process continues with step 524, in which it is determined whether the next line of text can be loaded for processing. If the next line of text cannot be loaded for processing, the process continues with step 526, and returns to the main loop at step 410 of FIG. 4. If the next line can be loaded for processing, then the process continues with step 528, in which the next line is loaded for processing. The process then continues with step 530, in which it is determined whether information included in the current line matches information specified by the regular expression. If information included in the current line matches information specified by the regular expression, then the process continues with step 532, in which markers are set at the matched text positions. In particular, a start marker is set at the start position of the matched text if the start position has been matched and an end marker is set at the end position of the matched text if an end position has been matched. The process then continues with step 526, and returns to the main loop at step 410 of FIG. 4.

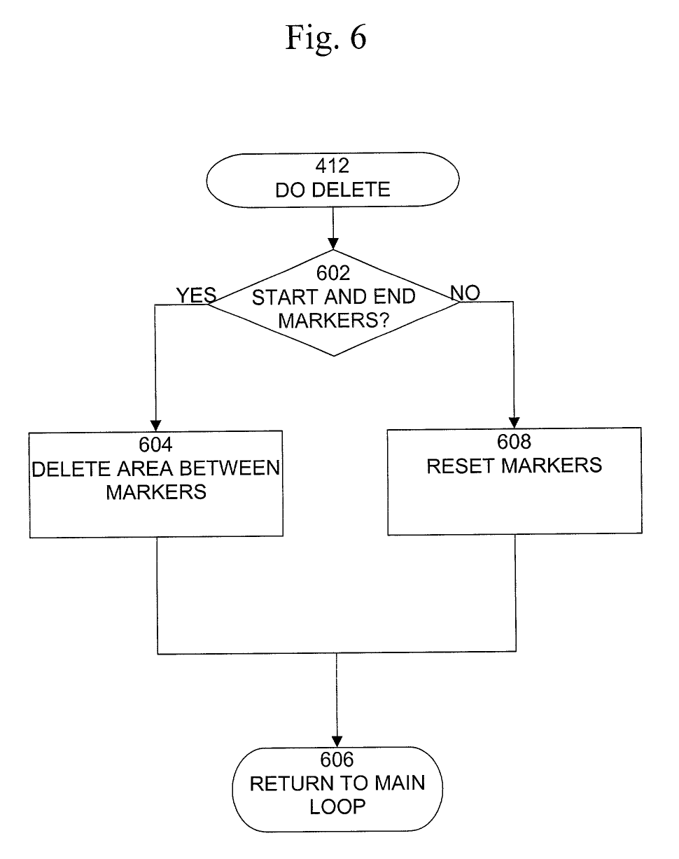

An exemplary flow diagram of a process performed by step 412 of FIG. 4, which performs the delete function, is shown in FIG. 6. The process of step 412 begins with step 602, in which it is determined whether both start and end markers have been set. If both start and end markers have been set, then the process continues with step 604, in which the area of text information between the set start and end markers is deleted. The process then continues with step 606, and returns to the main loop at step 410 of FIG. 4. If both start and end markers have not been set, then the process continues with step 608, in which any markers that have been set are reset. The process then continues with step 606, and returns to the main loop at step 414 of FIG. 4.

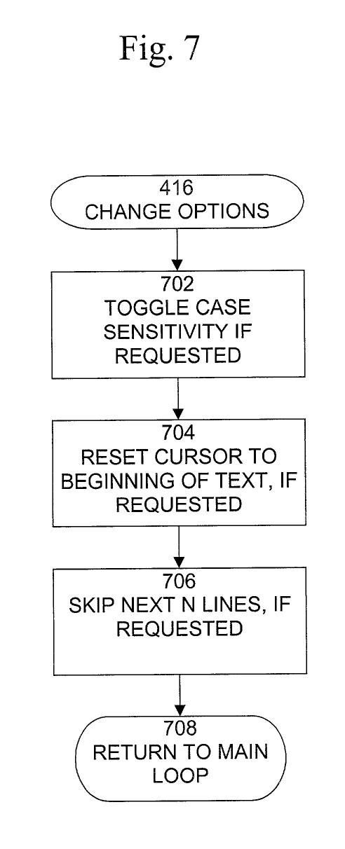

An exemplary flow diagram of a process performed by step 416 of FIG. 4, which changes search options, is shown in FIG. 7. The process of step 416 begins with step 702, in which case sensitivity is toggled if requested in the instant virus removal instruction. Case sensitivity indicates whether a match should be made only if text characters that otherwise match are of a particular case, that is, uppercase or lowercase. In step 704, the cursor, which indicates the point in the text that is being processed, is reset to the beginning of the text, if requested in the instant virus removal instruction. In step 706, a number of lines specified in the instant virus removal instruction are skipped if requested in the instant virus removal instruction. The process then continues with step 708, and returns to the main loop at step 418 of FIG. 4.

Regular expressions are text patterns that are used for string matching. Regular expressions are strings that contain a mix of plain text and special characters to indicate what kind of matching to do. An exemplary syntax table below illustrates a preferred embodiment of a regular expression syntax. This is only an example, as the present invention contemplates any and all other possible syntaxes. The table below lists and describes the function of each special character.

Syntax

A regular expression is zero or more branches, separated by ‘|’. It matches anything that matches one of the branches.

A branch is zero or more pieces, concatenated. It matches a match for the first, followed by a match for the second, etc.

A piece is an atom possibly followed by ‘*’, ‘+’, or ‘?’. An atom followed by ‘*’ matches a sequence of 0 or more matches of the atom. An atom followed by ‘+’ matches a sequence of 1 or more matches of the atom. An atom followed by ‘?’ matches a match of the atom, or the null string.

An atom is a regular expression in parentheses (matching a match for the regular expression), a range (see below), ‘.’ (matching any single character), (matching the null string at the beginning of the input string), ‘$’ (matching the null string at the end of the input string), a ‘\’ followed by a single character (matching that character), or a single character with no other significance (matching that character).

A range is a sequence of characters enclosed in ‘[ ]’. It normally matches any single character from the sequence. If the sequence begins with ‘ˆ ’, it matches any single character not from the rest of the sequence. If two characters in the sequence are separated by ‘-’, this is shorthand for the full list of ASCII characters between them (e.g. ‘[0-9]’ matches any decimal digit). To include a literal ‘]’ in the sequence, make it the first character (following a possible ‘ˆ ’) To include a literal ‘-’, make it the first or last character.

The parenthesis, besides affecting the evaluation order of the regular expression, also serves as markers. A marker refers to a part of the regular expression that is, because it was surrounded by parenthesis, accessible after a match has been made. There can be up to 10 markers (0-9) in any one regular expression. The 0th marker refers to the substring of string that matched the whole regular expression. The others refer to those substrings that matched parenthesized expressions within the regular expression, with parenthesized expressions numbered in left-to-right order of their opening parentheses. Note that the 0th marker is the only marker that does not require parentheses. In addition, each marker (under user control) either points to the first character of the substring or the last character of the substring.

A marker provides the location of matched text. As mentioned, In a preferred embodiment, there can be up to 10 markers in any one regular expression. Each marker can specify either the beginning or end of a matched sub-string. To select the text area to delete, two markers denoting the start and end positions are required. The start and end positions are specified as two bytes. The values for each byte denote a marker as follows, (values are hexadecimal.)

0—the beginning of the whole matched string

1—the beginning of the first parenthesized expression within the regular expression . . .

9—the beginning of the ninth parenthesized expression within the regular expression

10—the end of the whole matched string

11—the end of the first parenthesized expression within the regular expression . . .

19—the end of the ninth parenthesized expression within the regular expression

Any other value is ignored—the start and/or end positions of the area to be deleted remain unchanged.

The text editor reads in a line of text and applies an action command. When searching text, the editor loads each line according to the specified action and applies the pattern. The actions of the text editor are dependent on previous actions. For example, none of the actions can be used until the startaction is applied.

Examples of a preferred embodiment of a general syntax of the text editing actions are shown below. Unless otherwise stated, text edit actions have no arguments.

0×01—Load Current Module and Start Edit Initializes the editor to start editing the currently loaded text module. The module must have been loaded from either loadmodulesource, loadmodule, etc.

0×02—Load Particular Module and Start Edit Initializes the editor and loads a given text module for editing. Syntax: Textedit ModuleName

0×10—Match Current Line or Any Subsequent Line

0×11—Match Any Subsequent Line (Excluding Current)

0×12—Match Current Line

o×13—Match Next Line

0×14—Match Last Viable Line

0×15—Match Last Consecutive Line

Match a given pattern and place a start and/or end marker at the matched text.

Note: If the match can not be completed, the script will exit.

Syntax: Textedit 10 Start End Pattern

Start—beginning marker position. Refer to valid marker values above.

End—ending marker position. Refer to valid marker values above.

Pattern—regular expression

To select text areas that span multiple lines, it is necessary to first place a start marker while not setting an ending marker, a preferable hexadecimal value is ff for easy recognition. Then issue another action to set the ending marker and, this time, set ff for the start marker.

Examples:

;Delete Sub, End-Sub text spanning multiple lines.

;

;Find text and mark the beginning of match.

;Note: ending marker is not set.

Textedit 10 00 ff “sub”

;

;Find text and mark the end of match.

Textedit 10 ff 10 “end sub”

;Delete marked positions

Textedit 1F

;Find “‘1nternal” and mark the begin and end of the match.

Textedit 10 00 10 “‘1nternal”

;Delete single line match

Textedit 1F

;Find a match and mark at beginning and end of “subtext”

Textedit 10 01 11 “text (subtext) text2”

0×1F—Delete Marked Positions

Removes the area marked between begin and end markers and shrinks the file by that amount. Requires valid begin and end markers.

0×20—Global Pattern Match and Delete

Delete all text that matches the given pattern. This only works for single lines.

Syntax: Textedit 20 Start End Pattern

Example:

;Remove all instances of virus function call.

Textedit 20 00 0a “:IT”

0×30—Delete A Single MS Word 97 Macro Reference

0×31—Delete All MS Word 97 Macro References

References to macro subroutines stored in a MICROSOFT WORD97® file are complicated by parasitic macros. When repairing the user module, not only must the parasitic code be removed, but also any references to the parasitic subroutine. For instance, ThisDocument may have two subroutines, a user subroutine called UserCode, and the parasitic routine called AutoOpen. Once the AutoOpen subroutine is removed using the editing features, remove references (stored elsewhere) to it using the Delete-Single-MSWord97-Macro-Reference action. This will remove just the AutoOpen reference while keeping the UserCode reference intact. Specifically, the ThisDocument.AutoOpen reference is removed from the file.

If the parasitic virus generates a random subroutine name, use Delete-All-MsWord97-Macro-Reference. This action will remove valid user code references as well. (However, it will not delete the user code.)

Only Word97+ has been known to store references that, when not removed, will corrupt the file. References to macro subroutines in Excel97+ and PowerPoint97+ do not need to be considered.

Syntax: Textedit 30 Subroutine

Textedit 31

Example:

Textedit 30 “autoopen”

0×40—Reset Cursor Position To BOF

Move the cursor to the beginning of the file.

0×41—Turn Case Sensitivity Off (Default)

When matching text, do not consider case sensitivity.

0×42—Turn Case Sensitivity On

When matching text, consider case sensitivity.

0×4F—Display Current Line

For debugging purposes only, print the current line.

0×FF—Save Edit

Save modifications and update the document to use changes. If this action is not given, none of the changes will be applied to the text module—the virus will still be active. This action must the be the last action and is unique.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

### EXAMPLES

Example of parasitic macro

Sub Parastic_macro( )

‘Parastic infection code here

End Sub

‘User macro infected by parastic macro—Parastic macro runs when the user macro runs

Sub User_macro( ) Parastic_macro

‘legitimate code

End Sub

Examples of TEXT editor in action:

(Note examples are not parasitic macros)

Name qhit excel “X97M/Cauli” ;9811

NoQuick

LoadModule “cauliflower”

Detect Virus

Remove

Check “ ” 1c8b 1A0

;for Scan4.0.18

Check “ ” 17a7 1A0

XChec

textedit 1 ; edit this module

textedit 10 00 ff “Sub auto_open” ; mark first instance of function at begining

textedit 14 ff 10 “End Sub” ; mark last instance

textedit 1f ; delete marked positions

textedit ff ; save edit

; (series of text edit actually compiles to 1 verb)

Shrink 0

End

Name qhit word97 “W97M/Class” ;0003 mig

NoQuick

LoadClassModule

Detect Virus

Remove

Check “ ” 3236 11 ;generic—for Sub ToolsMacro

XChec

textedit 2 “thisdocument” ; edit ThisDocument module

textedit 20 00 10 “‘.+/.+/.+:.+:.+(AM|PM).+/.+/.+:.+:.+(AM|PM)”; remove all virus comments (uses expression to match)

textedit 10 00 ff “sub autoopen” ; mark autoopen

textedit 10 ff 10 “end sub” ; find next instance of end sub and mark

textedit 1f ; delete marked positions

textedit 30 “autoopen” ; remove autoopen reference

textedit 10 00 ff “sub viewvbcode” ; mark next function

textedit 10 ff 10 “end sub” ; mark end of function

textedit 1f ; delete

textedit 30 “viewvbcode” ; remove viewvbcode reference

textedit ff save edit

Shrink 0

End

Name qhit text “PP97M/Vic”;9902 mig

nvariant 1

NoQuick

Detect Virus

Remove

Check “.a” 56ea 203

Check “.b.intd” 56ee 203

XChec

NullModules

; example to delete everything.

textedit 1 ; edit this module

textedit 10 00 ff “.*” ; match anything and mark beginning

textedit 14 ff 10“.*” ; last match anything and mark end

textedit 1f ; delete marked

textedit ff ; save edit

; example to delete everything one character at a time

;textedit 1

;textedit 20 00 10 “.” ; match and delete all characters

;textedit ff

;deletethismodule

deletemodule “Slide1”

Shrink 0

End

What is claimed is:

1. An anti-virus program executable by a computer system, comprising:
virus scanning routines operable to scan a file and detect a virus;
virus removal routines operable to remove the detected virus from the file, the virus removal routines comprising a text editor, operable to search and modify a textual portion of the file under control of virus removal instructions; and
the virus removal instructions, which are operable to cause the text editor to remove a virus from the textual portion of the file.

2. The anti-virus program of claim 1, wherein the removed virus is located on one line of text.

3. The anti-virus program of claim 1, wherein the removed virus is located on a plurality of lines of text.

4. The anti-virus program of claim 1, wherein the text editor comprises a search function operable to search a textual portion of a file using a regular expression specifying a pattern of text to be matched.

5. The anti-virus program of claim 4, wherein the text editor comprises a mark function operable to mark text matching the regular expression that was found by the search function.

6. The anti-virus program of claim 5, wherein the text editor comprises a delete function operable to delete text marked by the mark function.

7. The anti-virus program of claim 6, wherein the mark function is operable to mark a start of text and an end of text.

8. The anti-virus program of claim 7, wherein the delete function is operable to delete text between the marked start of text and the marked end of text.

9. The anti-virus program of claim 8, wherein the deleted text is located on one line of text.

10. The anti-virus program of claim 8, wherein the deleted text is located on a plurality of lines of text.

11. The anti-virus program of claim 6, wherein:
the search function is operable to search for a start of text to be marked and the mark function is operable to mark a start marker at the start of text;
the search function is operable to search for an end of text to be marked and the mark function is operable to mark an end marker at the end of text; and
the delete function is operable to delete text between the start marker and the end marker.

12. A method for removing a virus from a textual portion of a file infected with a virus, comprising the steps of:
loading the infected file;
searching the infected file to locate text associated with the virus;
marking the located text; and
deleting the marked text.

13. The method of claim 8, wherein the searching step comprises the step of:
searching the infected file using a regular expression specifying a pattern of text to be matched.

14. The method of claim 9, wherein the searching step comprises the step of:
searching for a pattern of text associated with a start of text associated with the virus.

15. The method of claim 10, wherein the marking step comprises the step of:
placing a start marker at a start of text associated with the virus.

16. The method of claim 11, wherein the searching step comprises the step of:
searching for a pattern of text associated with an end of text associated with the virus.

17. The method of claim 12, wherein the marking step comprises the step of:
placing an end marker at an end of text associated with the virus.

18. The method of claim 13, wherein the deleting step comprises the step of:
deleting text between the start marker and the end marker.

19. A system for removing a virus from a textual portion of a file infected with a virus comprising:
a processor operable to execute computer program instructions;
a memory operable to store computer program instructions executable by the processor; and
computer program instructions stored in the memory and executable to perform the steps of:
loading the infected file;
searching the infected file to locate text associated with the virus;
marking the located text; and
deleting the marked text.

20. The system of claim 19, wherein the searching step comprises the step of:
searching the infected file using a regular expression specifying a pattern of text to be matched.

21. The system of claim 20, wherein the searching step comprises the step of:
searching for a pattern of text associated with a start of text associated with the virus.

22. The system of claim 21, wherein the marking step comprises the step of:
placing a start marker at a start of text associated with the virus.

23. The system of claim 22, wherein the searching step comprises the step of:
searching for a pattern of text associated with an end of text associated with the virus.

24. The system of claim 23, wherein the marking step comprises the step of:
placing an end marker at an end of text associated with the virus.

25. The system of claim 24, wherein the deleting step comprises the step of:
deleting text between the start marker and the end marker.

26. A computer program product for removing a virus from a textual portion of a file infected with a virus, comprising:
a computer readable medium;
computer program instructions, recorded on the computer readable medium, executable by a processor, for performing the steps of
loading the infected file;
searching the infected file to locate text associated with the virus;
marking the located text; and
deleting the marked text.

27. The computer program product of claim 26, wherein the searching step comprises the step of:
searching the infected file using a regular expression specifying a pattern of text to be matched.

28. The computer program product of claim 27, wherein the searching step comprises the step of:
searching for a pattern of text associated with a start of text associated with the virus.

29. The computer program product of claim 28, wherein the marking step comprises the step of:
placing a start marker at a start of text associated with the virus.

30. The computer program product of claim 29, wherein the searching step comprises the step of:
searching for a pattern of text associated with an end of text associated with the virus.

31. The computer program product of claim 30, wherein the marking step comprises the step of:
placing an end marker at an end of text associated with the virus.

32. The computer program product of claim 31, wherein the deleting step comprises the step of:
deleting text between the start marker and the end marker.
